(19) United States
(12) Patent Application Publication
(10) Pub. No.: US 2026/0225783 A1
(43) Pub. Date: Aug. 6, 2026

(54) MULTIPACK CARTON FOR CANNED PRODUCTS

(71) Applicant: GUANGZHOU WANGLAOJI GREAT HEALTH INDUSTRY CO., LTD., Guangzhou (CN)

(72) Inventors: Shaoquan WENG, Guangzhou (CN); Rongbo ZHENG, Guangzhou (CN); Cizhou LI, Guangzhou (CN); Haipeng YANG, Guangzhou (CN)

(73) Assignee: GUANGZHOU WANGLAOJI GREAT HEALTH INDUSTRY CO., LTD., Guangzhou (CN)

(21) Appl. No.: 19/457,141

(22) Filed: Jan. 22, 2026

(30) Foreign Application Priority Data
Nov. 22, 2024 (CN) 202422859237.7

(51) Int. Cl. B65D 71/32

(52) U.S. Cl. CPC B65D 71/32; B65D 2571/00222; B65D 2571/00444; B65D 2571/0066; B65D 2571/00716

(57) ABSTRACT

A multipack carton for canned products includes a lower base panel, a left side panel, a top panel, a right side panel, and an upper base panel connected in sequence and defining an accommodation space. The upper base panel is adhesively bonded to the lower base panel. A lower through-hole in the lower base panel is aligned with an upper through-hole in the upper base panel. A canned product unit can be placed into the accommodation space. A user can view product information marked on the bottom of each canned product through the lower and upper through-holes, and the user can insert a finger into the lower and upper through-holes sequentially to lift the multipack carton along with the canned product unit inside it, during which process a lifting force applied by the user is borne jointly by the lower and upper base panels.

The present application claims priority to the Chinese Patent Application No. 202422859237.7, titled "MULTIPACK CARTON FOR CANNED PRODUCTS", filed on November 22, 2024 with the China National Intellectual Property Administration, which is incorporated herein by reference in its entirety.

### FIELD

The present application relates to the technical field of packaging, and in particular to a multipack carton for canned products.

### BACKGROUND

Canning is a packaging method that seals products such as foods, beverages, and chemicals in containers such as metal cans or plastic jars. It offers advantages including excellent sealing properties, convenient transportation and storage, effective isolation from air, moisture, and light, as well as resistance to moderate external pressure and microbial contamination, thereby prolonging product shelf life. Currently, the most common and prevalent canned products on the market are canned beverages such as herbal teas, sodas, coffee, juice, and beer. Cardboard boxes or shrinkable films (also known as shrink films) are generally used to package multiple canned beverages. However, the cardboard boxes will completely cover the canned beverages, not only wasting packaging materials but also being inconvenient to carry, as well as preventing the canned beverages from being displayed. The shrink films go against an original intent of using paper packaging for environmental protection and are hard to recycle.

In the related art, multiple canned beverages are arranged together and then packaged using a multipack carton. Typically, the multipack carton only covers the bottom, the top, and two opposite sides of these canned beverages, offering advantages such as full display of the canned beverages, enhanced packaging aesthetics for better capturing consumer's attention, increased single-purchase quantity of canned beverages to aid promotional efforts, ergonomic design for convenient carrying, and being environmentally friendly due to paper-based material. However, to meet hand-carry requirement of the multipack carton, additional handles are often provided on the multipack carton, which increases production processes required for the multipack carton and reduces its production efficiency. Furthermore, when the multipack carton is grasped by a consumer via its handles, the handles are prone to breakage, which not only reduces stability of the multipack carton when carried by hand, but also severely impacts a shopping experience of the consumer.

### SUMMARY

A multipack carton for canned products is provided according to the present application, so as to address the issues of low production efficiency and poor hand-carry stability of the multipack carton in the related art.

To overcome the above drawbacks in the prior art, a multipack carton for canned products is provided according to the present application. The multipack carton is configured for packaging a canned product unit, which includes multiple canned products stacked or arranged together in a regular pattern. Specifically, the multipack carton includes panels. The panels include a top panel, a left side panel, a right side panel, a lower base panel, and an upper base panel. The lower base panel, the left side panel, the top panel, the right side panel, and the upper base panel are connected in the listed sequence. A first fold line is formed between each two panels that are connected to each other. A lower through-hole is provided in the lower base panel, and an upper through-hole is provided in the upper base panel. When the multipack carton is folded along the first fold lines, an accommodation space is defined by the lower base panel, the left side panel, the top panel, the right side panel, and the upper base panel. The upper base panel is adhesively bonded to the lower base panel. The upper through-hole is in alignment with the lower through-hole. The accommodation space is configured to accommodate the canned product unit. The top panel, the upper base panel, the left side panel, and the right side panel are configured to respectively abut against a top, a bottom, and two opposite lateral sides of the canned product unit. The lower through-hole and the upper through-hole are configured to allow a user to observe product information marked on the bottom of each canned product and allow insertion of the user's finger into the lower through-hole and the upper through-hole. The lower base panel and the upper base panel are configured to bear a lifting force applied by the user when the user's finger is inserted into the lower through-hole and upper through-hole sequentially.

In some embodiments, the lower base panel and the upper base panel are identical in shape and size. When the upper base panel is adhesively bonded to the lower base panel, an edge of the upper base panel away from to the right side panel abuts against the first fold line between the lower base panel and the left side panel.

In some embodiments, a number of the lower through-hole is at least one, and a number of the upper through-hole is at least one. In a case that multiple lower through-holes and multiple upper through-holes are provided, the multiple lower through-holes in the lower base panel are spaced apart from each other, and the multiple upper through-holes in the upper base panel are spaced apart from each other. The lower through-holes are configured to align with the respective upper through-holes. In an embodiment, four lower through-holes and four upper through-holes are provided. The four lower through-holes are arranged in a 2×2 array in the lower base panel, and the four upper through-holes are arranged in a 2×2 array in the upper base panel.

In some embodiments, the upper base panel has at least one adhesive application region configured for adhesive application. The upper base panel is bonded to the lower base panel via the adhesive applied in the adhesive application region.

In some embodiments, the upper base panel is provided with at least one adhesive strip with adhesive applied to its surface. The upper base panel is configured to be bonded to the lower base panel via the adhesive strip. In an embodiment, the adhesive strip is provided with multiple adhesive release holes spaced apart from each other, each of which is filled with the adhesive.

In some embodiments, the lower base panel, the left side panel, the top panel, the right side panel, and the upper base panel are all rectangular in shape. Opposite short edges of the left side panel are connected to the lower base panel and the top panel, respectively. Opposite short edges of the right side panel are connected to the top panel and the upper base panel, respectively. Each of opposite long edges of the left side panel is connected with a first protective panel. Opposite ends of the first protective panel are connected to the lower base panel and the top panel, respectively. Each of opposite long edges of the right side panel is connected with a second protective panel. Opposite ends of the second protective panel are connected to the top panel and the upper base panel, respectively. The first protective panel is configured to fold inward toward the accommodation space along the corresponding long edge of the left side panel under an external force after the canned product unit is placed into the accommodation space. The second protective panel is configured to fold inward toward the accommodation space along the corresponding long edge of the right side panel under an external force after the canned product unit is placed into the accommodation space.

In an embodiment, a contour of the first protective panel includes a first straight segment extending from a corner point of the lower base panel to the left side panel, a second straight segment extending from a corner point of the top panel to the left side panel, a first curved segment extending from the corner point of the lower base panel toward the left side panel, a second curved segment extending from the corner point of the top panel toward the left side panel, a third curved segment connecting the first curved segment and the second curved segment, and a third straight segment connecting the first straight segment and the second straight segment. The third straight segment coincides with the corresponding long edge of the left side panel, and the first straight segment and the second straight segment respectively coincide with corresponding edges of the lower base panel and the top panel. A second fold line is formed between each corner point of the left side panel close to the lower base panel and an intersection point of the first curved segment and the third curved segment of the corresponding first protective panel. A third fold line is formed between each corner point of the left side panel close to the top panel and an intersection point of the second curved segment and the third curved segment of the corresponding first protective panel. The first protective panel is divided by the second fold line and the third fold line into a first corner protection region connected to the lower base panel, a second corner protection region connected to the top panel, and a first edge protection region connecting the first corner protection region and the second corner protection region. A fourth fold line is formed at a corner of the lower base panel connected to the first corner protection region. The fourth fold line intersects the second fold line at the corner point of the left side panel close to the lower base panel. The fourth fold line defines a third corner protection region, which is connected to the first corner protection region, on the lower base panel. A fifth fold line is formed at a corner of the top panel connected to the second corner protection region. The fifth fold line intersects the third fold line at the corner point of the left side panel close to the top panel. The fifth fold line defines a fourth corner protection region, which is connected to the second corner protection region, on the top panel.

Specifically, the first edge protection region is configured to fold inward toward the accommodation space along the corresponding long edge of the left side panel after the canned product unit is placed into the accommodation space. The first corner protection region and the second corner protection region are configured to fold outward away from the accommodation space along the second fold line and the third fold line at the same time when the first edge protection region is folded inward toward the accommodation space along the corresponding long edge of the left side panel. The third corner protection region and the fourth corner protection region are configured to fold inward toward the accommodation space along the fourth fold line and the fifth fold line after the first corner protection region and the second corner protection region are folded outward away from the accommodation space along the second fold line and the third fold line. Further, a cutout is provided in the first edge protection region at an intersection point of the corresponding long edge of the left side panel and each of the second fold line and the third fold line.

In an embodiment, a contour of the second protective panel includes a fourth straight segment extending from a corner point of the upper base panel to the right side panel, a fifth straight segment extending from a corner point of the top panel to the right side panel, a fourth curved segment extending from the corner point of the upper base panel toward the right side panel, a fifth curved segment extending from the corner point of the top panel toward the right side panel, a sixth curved segment connecting the fourth curved segment and the fifth curved segment, and a sixth straight segment connecting the fourth straight segment and the fifth straight segment. The sixth straight segment coincides with the corresponding long edge of the right side panel, and the fourth straight segment and the fifth straight segment respectively coincide with corresponding edges of the upper base panel and the top panel. A sixth fold line is formed between each corner point of the right side panel close to the upper base panel and an intersection point of the fourth curved segment and the sixth curved segment of the corresponding second protective panel. A seventh fold line is formed between each corner point of the right side panel close to the top panel and an intersection point of the fifth curved segment and the sixth curved segment of the corresponding second protective panel. The second protective panel is divided by the sixth fold line and the seventh fold line into a fifth corner protection region connected to the upper base panel, a sixth corner protection region connected to the top panel, and a second edge protection region connecting the fifth corner protection region and the sixth corner protection region. An eighth fold line is formed at a corner of the upper base panel connected to the fifth corner protection region. The eighth fold line intersects the sixth fold line at the corner point of the right side panel close to the upper base panel. The eighth fold line defines a seventh corner protection region, which is connected to the fifth corner protection region, on the upper base panel. A ninth fold line is formed at a corner of the top panel connected to the sixth corner protection region. The ninth fold line intersects the seventh fold line at the corner point of the right side panel close to the top panel. The ninth fold line defines an eighth corner protection region, which is connected to the sixth corner protection region, on the top panel.

Specifically, the second edge protection region is configured to fold inward toward the accommodation space along the corresponding long edge of the right side panel after the canned product unit is placed into the accommodation space. The fifth corner protection region and the sixth corner protection region are configured to fold outward away from the accommodation space along the sixth fold line and the seventh fold line at the same time when the second edge protection region is folded inward toward the accommodation space along the corresponding long edge of the right side panel. The seventh corner protection region and the eighth corner protection region are configured to fold inward toward the accommodation space along the eighth fold line and the ninth fold line after the fifth corner protection region and the sixth corner protection region are folded outward away from the accommodation space along the sixth fold line and the seventh fold line. Further, a cutout is provided in the second edge protection region at an intersection point of the corresponding long edge of the right side panel and each of the sixth fold line and the seventh fold line.

In some embodiments, two corners of the lower base panel not connected to the left side panel and two corners of the upper base panel not connected to the right side panel are removed. A curved notch is provided at each of opposite edges of the lower base panel perpendicular to the first fold line, each of opposite edges of the top panel perpendicular to the first fold line, and each of opposite edges of the upper base panel perpendicular to the first fold line.

The multipack carton according to the present application includes the top panel, the left side panel, the right side panel, the lower base panel, and the upper base panel. The lower base panel, the left side panel, the top panel, the right side panel, and the upper base panel are connected in the listed sequence. The first fold line is formed between each two connected panels. When the multipack carton is folded along the first fold lines, the accommodation space is defined by the lower base panel, the left side panel, the top panel, the right side panel, and the upper base panel. The upper base panel is adhesively bonded to the lower base panel. The lower through-hole is provided in the lower base panel, and the upper through-hole is provided in the upper base panel and is in alignment with the lower through-hole. In practical applications, the canned product unit may be placed into the accommodation space, and the top panel, the upper base panel, the left side panel, and the right side panel respectively abut against the top, the bottom, and the two opposite lateral sides of the canned product unit. The user (e.g., a consumer) can look through the lower through-hole and the upper through-hole in sequence to view the product information such as a production date and an expiration date marked on the bottom of each canned product. The user can insert a finger into the lower through-hole and the upper through-hole in sequence to lift the multipack carton along with the canned product unit inside it, during which process the lifting force applied by the user is withstood jointly by the lower base panel and the upper base panel. Thus, when carrying the canned product unit (i.e., when moving the multipack carton while holding it by hand), the user can insert the finger into the lower through-hole in the lower base panel and the upper through-hole in the upper base panel in sequence to lift the multipack carton for movement. When the multipack carton is held by the user, the lifting force applied by the user is always withstood jointly by two panels (i.e., both the lower base panel and the upper base panel). Such dual-panel force-bearing configuration offers improved stability compared with conventional schemes with handles prone to breakage, thereby reducing the risk of falling of the multipack carton, improving the stability of the multipack carton when carried by hand, and thus ensuring a better shopping experience for the consumer. Moreover, the multipack carton according to the present application integrates the hand-carry function with the viewing function for information related to the canned products (both achieved through the lower through-hole and the upper through-hole), eliminating the need for additional handles on the multipack carton, thereby reducing the production processes required for the multipack carton to improve the production efficiency of the multipack carton.

### BRIEF DESCRIPTION OF THE DRAWINGS

To more clearly illustrate technical solutions in the related art or in embodiments of the present application, drawings used in description of the related art or the embodiments of the present application will be briefly introduced hereinafter. Apparently, the drawings in the following description only show some, but not all, of the embodiments of the present application, and other drawings may be obtained by those skilled in the art based on the provided drawings without any creative effort.

FIG. 1 is a schematic structural view of a multipack carton according to an embodiment of the present application.

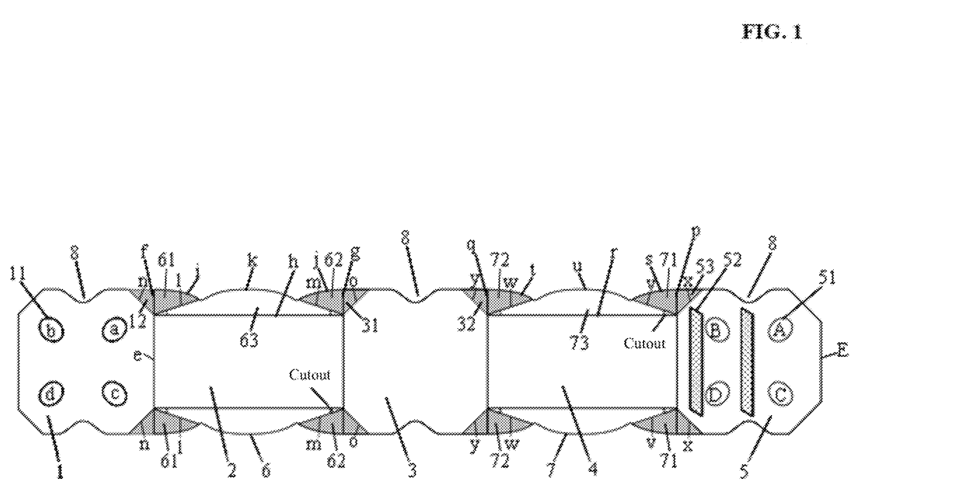

Reference numerals in FIG. 1 are listed as follows:

1. lower base panel; 2. left side panel;

3. top panel; 4. right side panel;

5. upper base panel; 6. first protective panel;

7. second protective panel; 8. curved notch;

11. lower through-hole; 12. third corner protection region;

31. fourth corner protection region; 32. eighth corner protection region;

51. upper through-hole; 52. adhesive application region;

53. seventh corner protection region; 61. first corner protection region;

62. second corner protection region; 63. first edge protection region;

71. fifth corner protection region; 72. sixth corner protection region;

73. second edge protection region; e. first fold line;

f. first straight segment; g. second straight segment;

h. third straight segment; i. first curved segment;

j. second curved segment; k. third curved segment;

l. second fold line; m. third fold line;

n. fourth fold line; o. fifth fold line;

p. fourth straight segment; q. fifth straight segment;

r. sixth straight segment; s. fourth curved segment;

t. fifth curved segment; u. sixth curved segment;

v. sixth fold line; w. seventh fold line;

x. eighth fold line; y. ninth fold line.

### DETAILED DESCRIPTION OF THE EMBODIMENTS

In the related art, multiple canned beverages are arranged together and then packaged using a multipack carton, which, compared with a cardboard and a shrink film, only covers the bottom, the top, and two opposite lateral sides of these canned beverages. Despite its various advantages, the multipack carton typically requires additional handles to meet hand-carry requirement, which increases production processes required for the multipack carton and reduces its production efficiency. Furthermore, when the multipack carton is grasped by a consumer via its handles, the handles are prone to breakage, causing the multipack carton to drop, thereby resulting in damage to the multipack carton or even breakage of the canned beverages. This not only reduces stability of the multipack carton when it is carried by hand, but also severely impacts a shopping experience of the consumer. In view of the above, a multipack carton for canned products is provided according to following embodiments of the present application to address the aforementioned issues in the related art.

Hereinafter, the present application will be described clearly and completely with reference to the embodiments of the present application and corresponding drawings to make the objects, technical solutions and advantages of the present application more obvious and easy to understand. Throughout the description, identical or similar reference numerals denote identical or similar elements or elements having the same or similar functions. It should be understood that the embodiments of the present application described below are intended only to illustrate, rather than limit, the present application. That is, all other embodiments obtained by those skilled in the art based on the embodiments of the present application without creative work shall fall within the scope of protection of the present application. In addition, technical features involved in the embodiments of the present application described below may be combined with each other as long as they do not conflict with each other.

Reference is made to FIG. 1, which is a schematic structural view of a multipack carton. A multipack carton for packaging a canned product unit is provided according to this embodiment. The canned product unit includes multiple canned products that are stacked or arranged in a regular pattern. It should be noted that the number of the canned products included in the canned product unit and the stacking or arrangement form of these canned products are determined based on actual needs and are not exclusively limited in the present application. For example, the canned product unit may include any one of the following: two canned products that are both placed vertically (also referred to as vertical placement, where a length of each canned product is perpendicular to a placement surface) and are arranged side by side; two canned products that are placed horizontally (also referred to as horizontal placement, where the length of each canned product is parallel to the placement surface) and are stacked together; four canned products that are placed vertically and are in contact with their adjacent ones in a 2×2 array; four canned products that are placed horizontally, with each pair of canned products stacked together to form one group, and the two groups of canned products arranged side by side; six canned products that are placed vertically and are in contact with their adjacent ones in a 2×3 array; eight canned products that are placed vertically and are in contact with their adjacent ones in a 2×4 array; and eight canned products that are placed vertically, with every four canned products in contact with their adjacent ones in a 2×2 array to form one group, and the two groups of canned products stacked together. It should also be noted that the canned product in this embodiment may be any canned food or beverage common in the related art, such as canned meat, canned vegetables, canned fruits, canned herbal tea, canned soda, canned coffee, canned juice, and canned beer, which may be selected based on actual needs and is not exclusively limited in the present application. Preferably, the multipack carton is made of coated kraft paper featuring long fibers, high density, high toughness, and high tear strength.

Specifically, the multipack carton according to this embodiment includes panels (not shown). The panels include a top panel 3, a left side panel 2, a right side panel 4, a lower base panel 1, and an upper base panel 5. The lower base panel 1, the left side panel 2, the top panel 3, the right side panel 4, and the upper base panel 5 are connected in the listed sequence. A first fold line e is formed between any two panels connected to each other. When the multipack carton is folded along the first fold lines e, an accommodation space (not shown) is defined by the lower base panel 1, the left side panel 2, the top panel 3, the right side panel 4, and the upper base panel 5. The upper base panel 5 is adhesively bonded to the lower base panel 1. A lower through-hole 11 is provided in the lower base panel 1, and an upper through-hole 51 is provided in the upper base panel 5 and is configured to align with the lower through-hole 11. In this embodiment, the accommodation space is configured to accommodate the canned product unit. The top panel 3 is configured to abut against a top of the canned product unit. The upper base panel 5 is configured to abut against a bottom of the canned product unit. The left side panel 2 and the right side panel 4 are configured to respectively abut against two opposite lateral sides of the canned product unit. The lower through-hole 11 and the upper through-hole 51 are configured to allow a user to observe product information such as a production date and an expiration date marked on the bottom of each canned product, and allow insertion of a finger of the user, such as a consumer, into the lower through-hole 11 and the upper through-hole 51 in sequence. The lower base panel 1 and the upper base panel 5 are configured to withstand a lifting force applied by the user after the user's finger is inserted into the lower through-hole 11 and the upper through-hole 51 in sequence.

In practical applications, the canned product unit may be placed into the accommodation space, and the top panel 3, the upper base panel 5, the left side panel 2, and the right side panel 4 respectively abut against the top, the bottom, and the two opposite lateral sides of the canned product unit. The user may look through the lower through-hole 11 and the upper through-hole 51 in sequence to view the product information marked on the bottom of each canned product. The user's finger may be inserted into the lower through-hole 11 and the upper through-hole 51 in sequence to lift the multipack carton along with the canned product unit inside it, during which process the lifting force applied by the user is withstood jointly by the lower base panel 1 and the upper base panel 5. Additionally, it should be noted that when the canned product unit is placed into the accommodation space, instead of being fully covered by the multipack carton, only the two opposite lateral sides of the canned product unit are covered by the multipack carton, which allows the canned products inside the canned product unit to remain sufficiently visible to the consumer for easy inspection of product details.

Thus, when carrying the canned product unit (i.e., when moving the multipack carton while holding it by hand), the user may insert a finger into the lower through-hole 11 in the lower base panel 1 and the upper through-hole 51 in the upper base panel 5 in sequence to lift the multipack carton for movement. During carrying of the multipack carton by the user, the lifting force applied by the user is borne jointly by two panels (i.e., both the lower base panel 1 and the upper base panel 5). Such dual-panel force-bearing configuration offers improved stability compared with conventional schemes with handles prone to breakage, thereby reducing the risk of falling of the multipack carton, improving the stability of the multipack carton when carried by hand, and thus ensuring a better shopping experience for the consumer. Furthermore, the multipack carton according to this embodiment integrates the hand-carry function with the viewing function for information related to the canned products (both achieved through the lower through-hole 11 and the upper through-hole 51), eliminating the need for additional handles on the multipack carton, thereby reducing the production processes required for the multipack carton to improve the production efficiency of the multipack carton.

In some embodiments, referring to FIG. 1, the lower base panel 1, and the upper base panel 5 are identical in shape and size. When the upper base panel 5 is adhesively bonded to the lower base panel 1 an edge of the upper base panel 5 away from the right side panel 4 (i.e., edge E in FIG. 1) abuts against the first fold line e between the lower base panel 1 and the left side panel 2. It should be understood that in the case that the lower base panel 1 and the upper base panel 5 are identical in shape and size, when the upper base panel 5 is adhesively bonded to the lower base panel 1, if the edge of the upper base panel 5 away from the right side panel 4 abuts against the first fold line e between the lower base panel 1 and the left side panel 2, it indicates that the upper base panel 5 and the lower base panel 1 are perfectly overlapped rather than being overlapped in a staggered manner (i.e., only partially overlapped), thereby improving resistance of the upper base panel 5 and the lower base panel 1 against the lifting force applied by the user, thus further improving the stability of the multipack carton when carried by hand. Alternatively, in other embodiments, the upper base panel 5 and the lower base panel 1 may be overlapped in a staggered manner when they are adhesively bonded together. The specific overlapping configuration of the upper base panel 5 and the lower base panel 1 may be determined based on actual needs, and is not exclusively limited in the present application. Moreover, it should be noted that since the upper base panel 5 and the lower base panel 1 exhibit strongest resistance against the lifting force applied by the user when they are fully overlapped, it is preferred that the upper base panel 5 and the lower base panel 1 are fully overlapped when they are adhesively bonded together.

In some embodiments, still referring to FIG. 1, both a number of the lower through-hole 11 and a number of the upper through-hole 51 are at least one. In a case that multiple lower through-holes 11 and multiple upper through-holes 51 are provided, the multiple lower through-holes 11 are spaced apart in the lower base panel 1, and the multiple upper through-holes 51 are spaced apart in the upper base panel 5. The multiple lower through-holes 11 are configured to align with the respective upper through-holes 51. It can be understood that when the user's finger is inserted into the lower through-hole 11 and the upper through-hole 51 sequentially to grasp the multipack carton, the more fingers inserted, the more stable the grasp on the multipack carton. Moreover, when numerous canned products are accommodated in the accommodation space, if only one lower through-hole 11 and one upper through-hole 51 are provided, it may be difficult to view the product information marked on the bottom of each canned product. Therefore, it is preferred that multiple lower through-holes 11 and multiple upper through-holes 51 are provided. The number of the lower through-holes 11 and the number of the upper through-holes 51 may be determined based on actual needs and are not exclusively limited in the present application, as long as the number of the lower through-holes 11 matches that of the upper through-holes 51 and the multiple lower through-holes 11 can align with the respective upper through-holes 51. In an example, four lower through-holes 11 and four upper through-holes 51 are provided. The four lower through-holes 11 (denoted by a, b, c, and d, respectively) are arranged in a 2×2 array in the lower base panel 1, and the four upper through-holes 51 (denoted by A, B, C, and D, respectively) are arranged in a 2×2 array in the upper base panel 5. When the upper base panel 5 is adhesively bonded to the lower base panel 1, alignment between the upper through-holes 51 and the lower through-holes 11 is as follows: the upper through-hole A is in alignment with the lower through-hole a; the upper through-hole B is in alignment with the lower through-hole b; the upper through-hole C is in alignment with the lower through-hole c; and the upper through-hole D is in alignment with the lower through-hole d.

In some embodiments, referring to FIG. 1, the lower base panel 1, the left side panel 2, the top panel 3, the right side panel 4, and the upper base panel 5 are all rectangular in shape. Opposite short edges of the left side panel 2 are connected to the lower base panel 1 and the top panel 3, respectively. Opposite short edges of the right side panel 4 are connected to the top panel 3 and the upper base panel 5, respectively. Each of opposite long edges of the left side panel 2 is connected with a first protective panel 6. Opposite ends of the first protective panel 6 are connected to the lower base panel 1 and the top panel 3, respectively. Each of opposite long edges of the right side panel 4 is connected with a second protective panel 7. Opposite ends of the second protective panel 7 are connected to the top panel 3 and the upper base panel 5, respectively. Specifically, the first protective panel 6 is configured to fold inward toward the accommodation space along the corresponding long edge of the left side panel 2 under an external force after the canned product unit is placed into the accommodation space. The second protective panel 7 is configured to fold inward toward the accommodation space along the corresponding long edge of the right side panel 4 under an external force after the canned product unit is placed into the accommodation space. That is, in practical applications, after placing the canned product unit into the accommodation space, the user may fold the first protective panel 6 and the second protective panel 7, such that the first protective panel 6 is folded inward toward the accommodation space along the corresponding long edge of the left side panel 2, and the second protective panel 7 is folded inward toward the accommodation space along the corresponding long edge of the right side panel 4. This provides protection to two opposite lateral sides of the canned product unit that are not in abutment with the left side panel 2 or the right side panel 4, thereby effectively preventing the canned products from departing from the accommodation space, i.e., reducing the risk of the canned products falling out of the accommodation space, and further improving the stability of the multipack carton when carried by hand.

In one or more embodiments, a contour of the first protective panel 6 includes a first straight segment f extending from a corner point (i.e., a vertex) of the lower base panel 1 to the left side panel 2, a second straight segment g extending from a corner point of the top panel 3 to the left side panel 2, a first curved segment i extending from the corner point of the lower base panel 1 toward the left side panel 2, a second curved segment j extending from the corner point of the top panel 3 toward the left side panel 2, a third curved segment k connecting the first curved segment i and the second curved segment j, and a third straight segment h connecting the first straight segment f and the second straight segment g. The third straight segment h coincides with the corresponding long edge of the left side panel 2, and the first straight segment f and the second straight segment g respectively coincide with corresponding edges of the lower base panel 1 and the top panel 3.

Specifically, a second fold line l is formed between each corner point of the left side panel 2 close to the lower base panel 1 and an intersection point of the first curved segment i and the third curved segment k of the corresponding first protective panel 6. A third fold line m is formed between each corner point of the left side panel 2 close to the top panel 3 and an intersection point of the second curved segment j and the third curved segment k of the corresponding first protective panel 6. The first protective panel 6 is divided by the second fold line l and the third fold line m into three regions, namely a first corner protection region 61 connected to the lower base panel 1, a second corner protection region 62 connected to the top panel 3, and a first edge protection region 63 connecting the first corner protection region 61 and the second corner protection region 62.

Further, a fourth fold line n is formed at a corner of the lower base panel 1 connected to the respective first corner protection region 61. The fourth fold line n intersects the second fold line l at the corner point of the left side panel 2 close to the lower base panel 1. The fourth fold line n defines a third corner protection region 12, which is connected to the first corner protection region 61, on the lower base panel 1. A fifth fold line o is formed at a corner of the top panel 3 connected to the respective second corner protection region 62. The fifth fold line o intersects the third fold line m at the corner point of the left side panel 2 close to the top panel 3. The fifth fold line o defines a fourth corner protection region 31, which is connected to the second corner protection region 62, on the top panel 3.

In practical applications, the first edge protection region 63 is configured to fold inward toward the accommodation space along the corresponding long edge of the left side panel 2 under an external force after the canned product unit is placed into the accommodation space. The first corner protection region 61 and the second corner protection region 62 are configured to fold outward away from the accommodation space along the second fold line l and the third fold line m at the same time when the first edge protection region 63 is folded inward toward the accommodation space along the corresponding long edge of the left side panel 2. The third corner protection region 12 and the fourth corner protection region 31 are configured to fold inward toward the accommodation space along the fourth fold line n and the fifth fold line o under an external force after the first corner protection region 61 and the second corner protection region 62 are folded outward away from the accommodation space along the second fold line l and the third fold line m.

That is, after placing the canned product unit into the accommodation space, the user may fold the first edge protection region 63, such that the first edge protection region 63 is folded inward toward the accommodation space along the corresponding long edge of the left side panel 2. At the same time, the first corner protection region 61 and the second corner protection region 62 are folded outward away from the accommodation space along the second fold line l and the third fold line m, respectively. After the first edge protection region 63, the first corner protection region 61, and the second corner protection region 62 are all folded into place, the user may fold the third corner protection region 12 and the fourth corner protection region 31, such that the third corner protection region 12 and the fourth corner protection region 31 are folded inward toward the accommodation space along the fourth fold line n and the fifth fold line o, respectively. In this way, protection is created for the two opposite lateral sides of the canned product unit that are not in abutment with the left side panel 2 or the right side panel 4. Preferably, to facilitate folding of the first edge protection region 63 inward toward the accommodation space along the corresponding long edge of the left panel 2, a cutout is provided in the first edge protection region 63 at an intersection point of the corresponding long edge of the left panel 2 and the second fold line l, and a cutout is provided in the first edge protection region 63 at an intersection point of the corresponding long edge of the left panel 2 and the third fold line m.

In one or more embodiments, a contour of the second protective panel 7 includes a fourth straight segment p extending from a corner point of the upper base panel 5 to the right side panel 4, a fifth straight segment q extending from a corner point of the top panel 3 to the right side panel 4, a fourth curved segment s extending from the corner point of the upper base panel 5 toward the right side panel 4, a fifth curved segment t extending from the corner point of the top panel 3 toward the right side panel 4, a sixth curved segment u connecting the fourth curved segment s and the fifth curved segment t, and a sixth straight segment r connecting the fourth straight segment p and the fifth straight segment q. The sixth straight segment r coincides with the corresponding long edge of the right side panel 4, and the fourth straight segment p and the fifth straight segment q respectively coincide with corresponding edges of the upper base panel 5 and the top panel 3.

Specifically, a sixth fold line v is formed between each corner point of the right side panel 4 close to the upper base panel 5 and an intersection point of the fourth curved segment s and the sixth curved segment u of the corresponding second protective panel 7. A seventh fold line w is formed between each corner point of the right side panel 4 close to the top panel 3 and an intersection point of the fifth curved segment t and the sixth curved segment u of the corresponding second protective panel 7. The second protective panel 7 is divided by the sixth fold line v and the seventh fold line w into three regions, namely a fifth corner protection region 71 connected to the upper base panel 5, a sixth corner protection region 72 connected to the top panel 3, and a second edge protection region 73 connecting the fifth corner protection region 71 and the sixth corner protection region 72.

Further, an eighth fold line x is formed at a corner of the upper base panel 5 connected to the respective fifth corner protection region 71. The eighth fold line x intersects the sixth fold line v at the corner point of the right side panel 4 close to the upper base panel 5. The eighth fold line x defines a seventh corner protection region 53, which is connected to the fifth corner protection region 71, on the upper base panel 5. A ninth fold line y is formed at a corner of the top panel 3 connected to the respective sixth corner protection region 72. The ninth fold line y intersects the seventh fold line w at the corner point of the right side panel 4 close to the top panel 3. The ninth fold line y defines an eighth corner protection region 32, which is connected to the sixth corner protection region 72, on the top panel 3.

In practical applications, the second edge protection region 73 is configured to fold inward toward the accommodation space along the corresponding long edge of the right side panel 4 under an external force after the canned product unit is placed into the accommodation space. The fifth corner protection region 71 and the sixth corner protection region 72 are configured to fold outward away from the accommodation space along the sixth fold line v and the seventh fold line w at the same time when the second edge protection region 73 is folded inward toward the accommodation space along the corresponding long edge of the right side panel 4. The seventh corner protection region 53 and the eighth corner protection region 32 are configured to fold inward toward the accommodation space along the eighth fold line x and the ninth fold line y under an external force after the fifth corner protection region 71 and the sixth corner protection region 72 are folded outward away from the accommodation space along the sixth fold line v and the seventh fold line w.

That is, after placing the canned product unit into the accommodation space, the user may fold the second edge protection region 73, such that the second edge protection region 73 is folded inward toward the accommodation space along the corresponding long edge of the right side panel 4. At the same time, the fifth corner protection region 71 and the sixth corner protection region 72 are folded outward away from the accommodation space along the sixth fold line v and the seventh fold line w, respectively. After the second edge protection region 73, the fifth corner protection region 71, and the sixth corner protection region 72 are all folded into place, the user may fold the seventh corner protection region 53 and the eighth corner protection region 32, such that the seventh corner protection region 53 and the eighth corner protection region 32 are folded inward toward the accommodation space along the eighth fold line x and the ninth fold line y, respectively. In this way, protection is created for the two opposite lateral sides of the canned product unit that are not in abutment with the left side panel 2 or the right side panel 4. Preferably, to facilitate folding of the second edge protection region 73 into the accommodation space along the corresponding long edge of the right side panel 4, a cutout is provided in the second edge protection region 73 at an intersection point of the corresponding long edge of the right side panel 4 and the sixth fold line v, and a cutout is provided in the second edge protection region 73 at an intersection point of the corresponding long edge of the right side panel 4 and the seventh fold line w.

In some embodiments, still referring to FIG. 1, the upper base panel 5 has at least one adhesive application region 52. Adhesive can be applied in the adhesive application region 52, enabling the upper base panel 5 to be bonded to the lower base panel 1 via the adhesive in the adhesive application region 52. It should be understood that when the accommodation space is enclosed by the lower base panel 1, the left side panel 2, the top panel 3, the right side panel 4, and the upper base panel 5, the upper base panel 5 needs to be bonded to the lower base panel 1. In view of this, according to the present application, the at least one adhesive application region 52 for adhesive application is provided on the upper base panel 5, enabling bonding of the upper base panel 5 to the lower base panel 1 via the adhesive in the adhesive application region 52. Additionally, it should be noted that both the enclosure of the accommodation space and the bonding of the upper base panel 5 to the lower base panel 1 are completed before the multipack carton leaves the factory. That is, prior to the multipack carton leaving the factory, the accommodation space is enclosed and the upper base panel 5 is adhesively bonded to the lower base panel 1 automatically by relevant devices. In this case, after the multipack carton leaves the factory, packaging personnel only need to fold the first protective panels 6, the second protective panels 7, and related parts, eliminating the need for enclosing the accommodation space and adhesively bonding the upper base panel 5 to the lower base panel 1 during the packaging process of the canned product unit, thereby significantly simplifying the packaging process of the canned product unit and thus improving packaging efficiency thereof.

The bonding structure on the upper base panel 5 is not limited to the adhesive application region 52. In other embodiments, the adhesive application region 52 may be replaced with an adhesive strip (not shown), i.e., at least one adhesive strip is arranged on the upper base panel 5 with adhesive applied to a surface of the adhesive strip. In this way, the upper base panel 5 may be bonded to the lower base panel 1 via the adhesive strip. Preferably, the adhesive strip is provided with multiple adhesive release holes (not shown) spaced apart from each other, each of which is filled with the adhesive. That is, the adhesive not only is applied to the surface of the adhesive strip but also fills the multiple adhesive release holes formed therein. Consequently, when bonding the upper base panel 5 to the lower base panel 1, the adhesive in each adhesive release hole is released, thereby improving bonding effectiveness between the upper base panel 5 and the lower base panel 1, ensuring overall stability of the multipack carton, and further improving the stability of the multipack carton when carried by hand.

In some embodiments, still referring to FIG. 1, to balance material consumption, production cost, and the stability of the multipack carton, two corners of the lower base panel 1 not connected to the left side panel 2 are removed, and two corners of the upper base panel 5 not connected to the right side panel 4 are removed. A curved notch 8 is provided at each of opposite edges of the lower base panel 1 perpendicular to the first fold line e. A curved notch 8 is provided at each of opposite edges of the top panel 3 perpendicular to the first fold line e. A curved notch 8 is provided at each of opposite edges of the upper base panel 5 perpendicular to the first fold line e. Such configuration optimizes the material consumption, the production cost, and the stability of the multipack carton.

The above embodiments are merely preferred embodiments of the present application and do not constitute exclusive limitations on contents related to the multipack carton. In view of this, those skilled in the art can make flexible settings according to actual application scenarios on the basis of the above embodiments. It should be understood that through implementation of the above embodiments of the present application, the multipack carton includes the top panel 3, the left side panel 2, the right side panel 4, the lower base panel 1, and the upper base panel 5. The lower base panel 1, the left side panel 2, the top panel 3, the right side panel 4, and the upper base panel 5 are connected in the listed sequence. The first fold line e is formed between any two connected panels. When the multipack carton is folded along each first fold line e, the accommodation space is defined by the lower base panel 1, the left side panel 2, the top panel 3, the right side panel 4, and the upper base panel 5. The upper base panel 5 is adhesively bonded to the lower base panel 1. The lower through-hole 11 is provided in the lower base panel 1, and the upper through-hole 51 is provided in the upper base panel 5 and is configured to align with the lower through-hole 11. In practical applications, the canned product unit may be placed into the accommodation space, and the top panel 3, the upper base panel 5, the left side panel 2, and the right side panel 4 are configured to respectively abut against the top, the bottom, and the two opposite lateral sides of the canned product unit. The consumer may look through the lower through-hole 11 and the upper through-hole 51 sequentially to view the product information such as a production date and an expiration date marked on the bottom of each canned product. The consumer may insert the finger into the lower through-hole 11 and the upper through-hole 51 sequentially to lift the multipack carton along with the canned product unit inside it, during which process the lifting force applied by the consumer is borne jointly by the lower base panel 1 and the upper base panel 5. Thus, when carrying the canned product unit (i.e., when moving the multipack carton while holding it by hand), the consumer can insert the finger into the lower through-hole 11 in the lower base panel 1 and the upper through-hole 51 in the upper base panel 5 sequentially to lift the multipack carton for movement. During carrying of the multipack carton by the consumer, the lifting force applied by the consumer is borne jointly by two panels (i.e., both the lower base panel 1 and the upper base panel 5). Such dual-panel force-bearing configuration offers improved stability compared with conventional schemes with handles prone to breakage, thereby reducing the risk of falling of the multipack carton, improving the stability of the multipack carton when carried by hand, and thus ensuring a better shopping experience for the consumer. Moreover, the multipack carton according to the present application integrates the hand-carry function with the viewing function for information related to the canned products (both achieved through the lower through-hole 11 and the upper through-hole 51), eliminating the need for additional handles on the multipack carton, thereby reducing the production processes required for the multipack carton to improve the production efficiency of the multipack carton.

It should be noted that above embodiments illustrated in the present application are described in a progressive manner, with each focusing on its differences from other embodiments, and references may be made among these embodiments with respect to the same or similar portions. It should also be noted that in the textual description of the present application, relational terms such as "first" and "second" are used merely to distinguish one entity or operation from another, rather than necessitating or implying any actual relationship or order between these entities or operations. Further, the terms "comprising", "including" or any other variations thereof are intended to encompass non-exclusive inclusion, such that a process, a method, an object, or a device including a series of elements not only includes the listed elements, but also includes other elements not explicitly listed, or inherent elements of the process, the method, the object, or the device. Moreover, without more limitations, an element defined by a phrase "including a..." does not exclude a case that there is another same element in the process, the method, the object or the device including the described element.

In addition, those skilled in the art can realize or use the present application by implementing the above embodiments illustrated in the present application. Numerous modifications to the above embodiments illustrated in the present application are apparent to those skilled in the art. The general principles defined in the present application can be realized in other embodiments not shown herein without departing from the spirit or scope of the present application. Therefore, the present application will not be limited to the above several embodiments illustrated in the foregoing, but is to be conformed to the broadest scope consistent with the principles and novel features disclosed in the present application.

1. A multipack carton, configured for packaging a canned product unit, the canned product unit comprising a plurality of canned products stacked or arranged in a regular pattern, wherein
the multipack carton comprises panels, the panels comprise a lower base panel, a left side panel, a top panel, a right side panel, and an upper base panel that are connected in the listed sequence, a first fold line is formed between each two connected panels, a lower through-hole is provided in the lower base panel, and an upper through-hole is provided in the upper base panel; and
when the multipack carton is folded along the first fold lines, an accommodation space is defined by the lower base panel, the left side panel, the top panel, the right side panel, and the upper base panel, the upper base panel is adhesively bonded to the lower base panel, and the upper through-hole is in alignment with the lower through-hole, wherein
the accommodation space is configured to accommodate the canned product unit;
the top panel, the upper base panel, the left side panel, and the right side panel are configured to respectively abut against a top, a bottom, and two opposite lateral sides of the canned product unit;
the lower through-hole and the upper through-hole are configured to allow product information marked on a bottom of each canned product to be visible and accommodate a finger; and
the lower base panel and the upper base panel are configured to withstand a lifting force after the finger is inserted into the lower through-hole and upper through-hole.

2. The multipack carton according to claim 1, wherein
the lower base panel and the upper base panel are identical in shape and size; and
when the upper base panel is adhesively bonded to the lower base panel, an edge of the upper base panel away from the right side panel abuts against the first fold line between the lower base panel and the left side panel.

3. The multipack carton according to claim 1, wherein
a number of the lower through-hole is plural, a number of the upper through-hole is plural, the plurality of lower through-holes are spaced apart from each other in the lower base panel, the plurality of upper through-holes are spaced apart from each other in the upper base panel, and the lower through-holes are configured to align with the respective upper through-holes.

4. The multipack carton according to claim 3, wherein the number of the lower through-holes is four, the number of the upper through-holes is four, the four lower through-holes are arranged in a 2×2 array in the lower base panel, and the four upper through-holes are arranged in a 2×2 array in the upper base panel.

5. The multipack carton according to claim 1, wherein the upper base panel is provided with at least one adhesive application region configured for adhesive application, and the upper base panel is configured to be bonded to the lower base panel via adhesive applied in the adhesive application region.

6. The multipack carton according to claim 1, wherein the upper base panel is provided with at least one adhesive strip, adhesive is applied to a surface of the adhesive strip, and the upper base panel is configured to be bonded to the lower base panel via the adhesive strip.

7. The multipack carton according to claim 6, wherein the adhesive strip is provided with a plurality of adhesive release holes that are spaced apart from each other, and each of the adhesive release holes is filled with the adhesive.

8. The multipack carton according to claim 1, wherein
the lower base panel, the left side panel, the top panel, the right side panel, and the upper base panel are all rectangular in shape, opposite short edges of the left side panel are respectively connected to the lower base panel and the top panel, and opposite short edges of the right side panel are respectively connected to the top panel and the upper base panel; and
each of opposite long edges of the left side panel is connected with a first protective panel, opposite ends of the first protective panel are respectively connected to the lower base panel and the top panel, each of opposite long edges of the right side panel is connected with a second protective panel, and opposite ends of the second protective panel are respectively connected to the top panel and the upper base panel, wherein
the first protective panel is configured to fold inward toward the accommodation space along the corresponding long edge of the left side panel after the canned product unit is placed into the accommodation space; and
the second protective panel is configured to fold inward toward the accommodation space along the corresponding long edge of the right side panel after the canned product unit is placed into the accommodation space.

9. The multipack carton according to claim 8, wherein
a contour of the first protective panel comprises a first straight segment extending from a corner point of the lower base panel to the left side panel, a second straight segment extending from a corner point of the top panel to the left side panel, a first curved segment extending from the corner point of the lower base panel toward the left side panel, a second curved segment extending from the corner point of the top panel toward the left side panel, a third curved segment connecting the first curved segment and the second curved segment, and a third straight segment connecting the first straight segment and the second straight segment;
the third straight segment coincides with the corresponding long edge of the left side panel, and the first straight segment and the second straight segment respectively coincide with corresponding edges of the lower base panel and the top panel;
a second fold line is formed between each corner point of the left side panel close to the lower base panel and an intersection point of the first curved segment and the third curved segment of the corresponding first protective panel, a third fold line is formed between each corner point of the left side panel close to the top panel and an intersection point of the second curved segment and the third curved segment of the corresponding first protective panel, the first protective panel is divided by the second fold line and the third fold line into a first corner protection region connected to the lower base panel, a second corner protection region connected to the top panel, and a first edge protection region connecting the first corner protection region and the second corner protection region;
a fourth fold line is formed at a corner of the lower base panel connected to the first corner protection region, and the fourth fold line intersects the second fold line at the corner point of the left side panel close to the lower base panel, the fourth fold line defines a third corner protection region, which is connected to the first corner protection region, on the lower base panel; and
a fifth fold line is formed at a corner of the top panel connected to the second corner protection region, the fifth fold line intersects the third fold line at the corner point of the left side panel close to the top panel, and the fifth fold line defines a fourth corner protection region, which is connected to the second corner protection region, on the top panel, wherein
the first edge protection region is configured to fold inward toward the accommodation space along the corresponding long edge of the left side panel after the canned product unit is placed into the accommodation space;
the first corner protection region and the second corner protection region are configured to fold outward away from the accommodation space along the second fold line and the third fold line when the first edge protection region is folded inward toward the accommodation space along the corresponding long edge of the left side panel; and
the third corner protection region and the fourth corner protection region are configured to fold inward toward the accommodation space along the fourth fold line and the fifth fold line after the first corner protection region and the second corner protection region are folded outward away from the accommodation space along the second fold line and the third fold line.

10. The multipack carton according to claim 9, wherein a cutout is provided in the first edge protection region at an intersection point of the corresponding long edge of the left side panel and each of the second fold line and the third fold line.

11. The multipack carton according to claim 8, wherein
a contour of the second protective panel comprises a fourth straight segment extending from a corner point of the upper base panel to the right side panel, a fifth straight segment extending from a corner point of the top panel to the right side panel, a fourth curved segment extending from the corner point of the upper base panel toward the right side panel, a fifth curved segment extending from the corner point of the top panel toward the right side panel, a sixth curved segment connecting the fourth curved segment and the fifth curved segment, and a sixth straight segment connecting the fourth straight segment and the fifth straight segment;
the sixth straight segment coincides with the corresponding long edge of the right side panel, and the fourth straight segment and the fifth straight segment respectively coincide with corresponding edges of the upper base panel and the top panel;
a sixth fold line is formed between each corner point of the right side panel close to the upper base panel and an intersection point of the fourth curved segment and the sixth curved segment of the corresponding second protective panel, a seventh fold line is formed between each corner point of the right side panel close to the top panel and an intersection point of the fifth curved segment and the sixth curved segment of the corresponding second protective panel, the second protective panel is divided by the sixth fold line and the seventh fold line into a fifth corner protection region connected to the upper base panel, a sixth corner protection region connected to the top panel, and a second edge protection region connecting the fifth corner protection region and the sixth corner protection region;
an eighth fold line is formed at a corner of the upper base panel connected to the fifth corner protection region, the eighth fold line intersects the sixth fold line at the corner point of the right side panel close to the upper base panel, and the eighth fold line defines a seventh corner protection region, which is connected to the fifth corner protection region, on the upper base panel; and
a ninth fold line is formed at a corner of the top panel connected to the sixth corner protection region, the ninth fold line intersects the seventh fold line at the corner point of the right side panel close to the top panel, and the ninth fold line defines an eighth corner protection region, which is connected to the sixth corner protection region, on the top panel, wherein
the second edge protection region is configured to fold inward toward the accommodation space along the corresponding long edge of the right side panel after the canned product unit is placed into the accommodation space;
the fifth corner protection region and the sixth corner protection region are configured to fold outward away from the accommodation space along the sixth fold line and the seventh fold line when the second edge protection region is folded inward toward the accommodation space along the corresponding long edge of the right side panel; and
the seventh corner protection region and the eighth corner protection region are configured to fold inward toward the accommodation space along the eighth fold line and the ninth fold line after the fifth corner protection region and the sixth corner protection region are folded outward away from the accommodation space along the sixth fold line and the seventh fold line.

12. The multipack carton according to claim 11, wherein a cutout is provided in the second edge protection region at an intersection point of the corresponding long edge of the right side panel and each of the sixth fold line and the seventh fold line.

13. The multipack carton according to claim 8, wherein two corners of the lower base panel not connected to the left side panel and two corners of the upper base panel not connected to the right side panel are removed, and a curved notch is provided at each of opposite edges of the lower base panel, the top panel, and the upper base panel that are perpendicular to the first fold line.
